(19) United States
(12) Patent Application Publication
(10) Pub. No.: US 2025/0275642 A1
(43) Pub. Date: Sep. 4, 2025

(54) REUSABLE COFFEE AND BEVERAGE POD

(71) Applicant: Conair LLC, Stamford, CT (US)

(72) Inventors: Wing Po CHAN, Hong Kong (CN); Yik On YIU, Hong Kong (CN)

(73) Assignee: Conair LLC, Stamford, CT (US)

(21) Appl. No.: 18/591,085

(22) Filed: Feb. 29, 2024

(51) Int. Cl. A47J 31/06

(52) U.S. Cl. CPC A47J 31/0689; A47J 31/0605

(57) ABSTRACT

A coffee and beverage pod includes a body having an interior volume for receiving a beverage ingredient. The coffee and beverage pod is selectively configurable in a low-pressure brewing mode and a high-pressure brewing mode. In the low-pressure brewing mode, a first pressure is necessary to allow for the flow of liquid from the interior volume out of an outlet in the body, and in the high-pressure brewing mode, a second pressure within the interior volume is necessary to allow for the flow of liquid from the interior volume out of the outlet, the second pressure being greater than the first pressure.

### FIELD OF THE INVENTION

The present invention relates generally to accessories for beverage making devices and, more particularly, to a reusable coffee and beverage pod for a beverage making machine.

### BACKGROUND OF THE INVENTION

Various types of beverage brewers, such as single-serve beverage brewers, have been developed and are popular for home brewing of coffee and other beverages. In a typical single-serve beverage brewer, a disposable beverage filter cartridge containing a dry beverage medium (such as tea or coffee) is disposed within a filter cartridge holder or brewing holster of a beverage or coffee machine. To brew the beverage, the filter cartridge is pierced by inlet and outlet probes to accommodate a through-flow of metered hot water. The hot water infuses the dry beverage medium contained in the cartridge to thereby produce a single serving of the beverage. After the beverage is brewed, the cartridge is removed from the cartridge holder and it is discarded.

By requiring the use of the disposable cartridges, consumers are limited to the beverage selection of the cartridges on hand. Moreover, with each cartridge being disposed of after use, there is much needless waste. In addition, existing coffee machines and single-serve cartridges, including those of the reusable variety, are only capable of brewing a single type of coffee such as, for example, espresso or drip coffee, but not both.

In view of the above, there is a need for a reusable coffee and beverage pod suitable for use with a beverage brewer that can be used with any desired dry beverage medium (coffee, tea, etc.) and which can used to brew a variety of different types of coffee at different pressures.

### SUMMARY OF THE INVENTION

It is an object of the present invention to provide a reusable coffee and beverage pod.

It is another object of the present invention to provide a reusable coffee and beverage pod configured for use in brewing various types of coffee such as espresso and drip coffee.

It is another object of the present invention to provide a reusable coffee and beverage pod configured for use in brewing coffee and other beverages at different pressures.

It is another object of the present invention to provide a reusable coffee and beverage pod that prevents over-pressure conditions.

These and other objects are achieved by the present invention.

According to an embodiment of the present invention, a coffee and beverage pod includes a body having an interior volume for receiving a beverage ingredient. The coffee and beverage pod is selectively configurable in a low-pressure brewing mode and a high-pressure brewing mode. In the low-pressure brewing mode, a first pressure is necessary to allow for the flow of liquid from the interior volume out of an outlet in the body, and in the high-pressure brewing mode, a second pressure within the interior volume is necessary to allow for the flow of liquid from the interior volume out of the outlet, the second pressure being greater than the first pressure.

According to yet another embodiment of the present invention, a coffee and beverage pod includes an upper chamber configured to receive a beverage ingredient, and having an outlet, a lower chamber having an outlet, and an adjustable pressure valve having a sealing element. The adjustable pressure valve is moveable between a first position where the sealing element is spaced from the outlet of the upper chamber to provide fluid communication between the upper chamber and the lower chamber, and a second position where the sealing element engages the outlet of the upper chamber to fluidly isolate the upper chamber from the lower chamber.

According to yet another embodiment of the present invention, a method for brewing a beverage includes the steps of placing a beverage ingredient inside an upper chamber of a beverage pod, the upper chamber having an outlet, and configuring the beverage pod for one of a high-pressure brewing mode or a low-pressure brewing mode. Configuring the beverage pod for the high-pressure brewing mode includes moving an adjustable pressure valve to be in contact with the outlet to inhibit fluid from exiting the upper chamber through the outlet, and configuring the beverage pod for the low-pressure brewing mode includes moving the adjustable pressure valve to a position where it is spaced from the outlet to allow fluid to exit the upper chamber through the outlet.

### BRIEF DESCRIPTION OF THE DRAWINGS

The present invention will be better understood from reading the following description of non-limiting embodiments, with reference to the attached drawings, wherein below:

FIG. 1 is a perspective, top view of a reusable coffee and beverage pod according to an embodiment of the invention.

FIG. 2 is a perspective, bottom view of the reusable coffee and beverage pod of FIG. 1.

FIG. 3 is a top plan view of the reusable coffee and beverage pod of FIG. 1.

FIG. 4 is a bottom plan view of the reusable coffee and beverage pod of FIG. 1.

FIG. 5 is a right side elevational view of the reusable coffee and beverage pod of FIG. 1.

FIG. 6 is a side, cross-sectional view of the reusable coffee and beverage pod of FIG. 1.

FIG. 7 is a cross-sectional, perspective view of the reusable coffee and beverage pod of FIG. 1.

FIG. 8 is an exploded, perspective view of the reusable coffee and beverage pod of FIG. 1.

FIG. 9 is an enlarged, perspective view of an adjustable pressure valve of the reusable coffee and beverage pod of FIG. 1.

FIG. 10 is a perspective view of the reusable coffee and beverage pod of FIG. 1, illustrating movement of the adjustable pressure valve to a closed position.

FIG. 11 is a cross-sectional view of the reusable coffee and beverage pod of FIG. 1, showing the adjustable pressure valve in the closed position.

FIG. 12 is a cross-sectional, perspective view of the reusable coffee and beverage pod taken along line A-A of FIG. 3, showing the adjustable pressure valve in the closed position.

FIG. 13 is a perspective view of the reusable coffee and beverage pod of FIG. 1, illustrating movement of the adjustable pressure valve to an open position.

FIG. 14 is a cross-sectional view of the reusable coffee and beverage pod of FIG. 1, showing the adjustable pressure valve in the open position.

FIG. 15 is a cross-sectional, perspective view of the reusable coffee and beverage pod taken along line A-A of FIG. 3, showing the adjustable pressure valve in the open position.

FIG. 16 is a cross-sectional view of the reusable coffee and beverage pod of FIG. 1, illustrating operation thereof.

FIG. 17 is an enlarged, cross-sectional view of a portion of the reusable coffee and beverage pod, showing the flow of water therethrough.

FIG. 18 is a cross-sectional view of the reusable coffee and beverage pod of FIG. 1, illustrating a high-pressure brewing operation.

FIG. 19 is a cross-sectional, perspective view of the reusable coffee and beverage pod of FIG. 1, illustrating a high-pressure brewing operation.

FIG. 20 is a cross-sectional view of the reusable coffee and beverage pod of FIG. 1, illustrating a low-pressure brewing operation.

FIG. 21 is a cross-sectional, perspective view of the reusable coffee and beverage pod of FIG. 1, illustrating a low-pressure brewing operation.

FIG. 22 is a cross-sectional view of a reusable coffee and beverage pod according to another embodiment of the present invention, illustrating a high-pressure mode of operation.

FIG. 23 is a cross-sectional view of the reusable coffee and beverage pod of FIG. 22, illustrating an over pressure condition.

### DETAILED DESCRIPTION OF THE PREFERRED EMBODIMENT

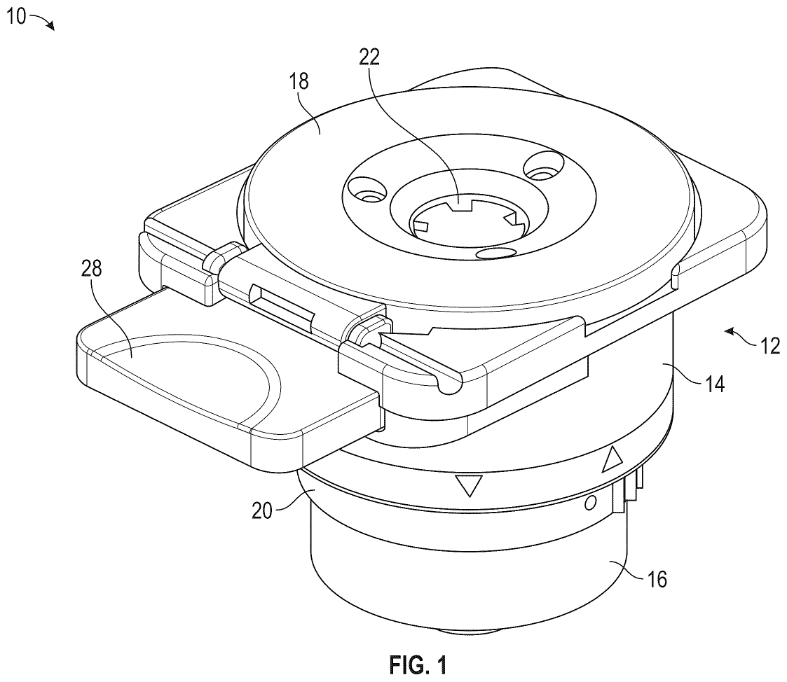

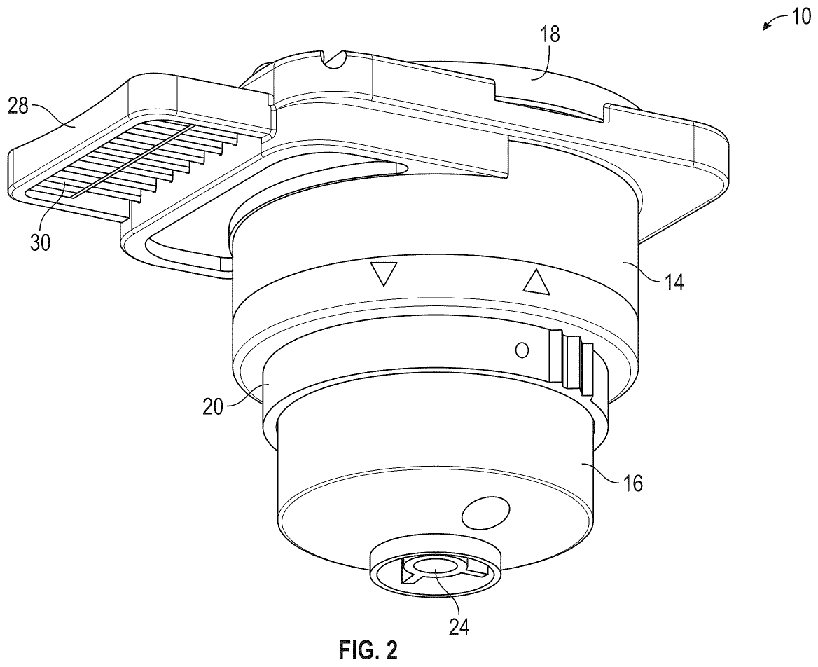

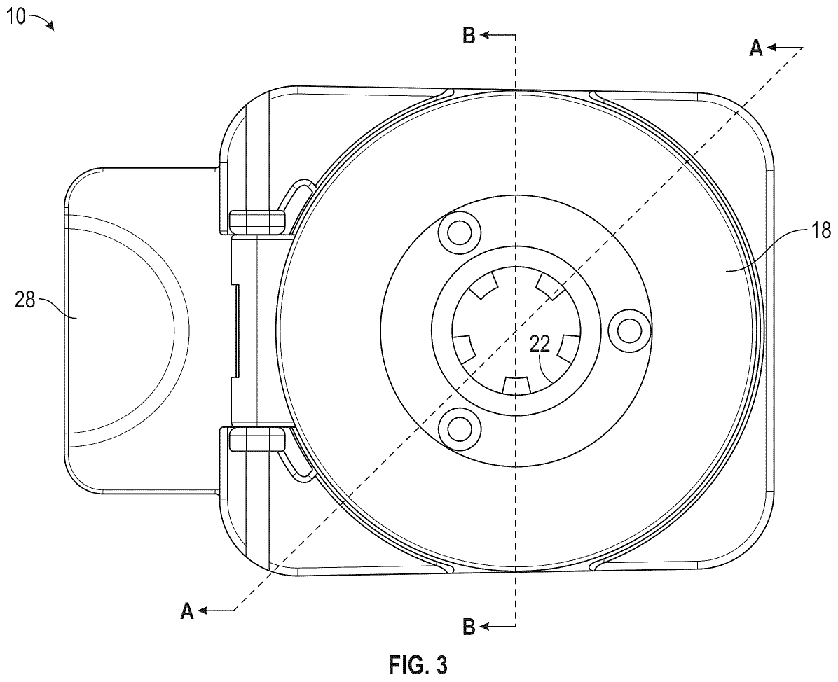

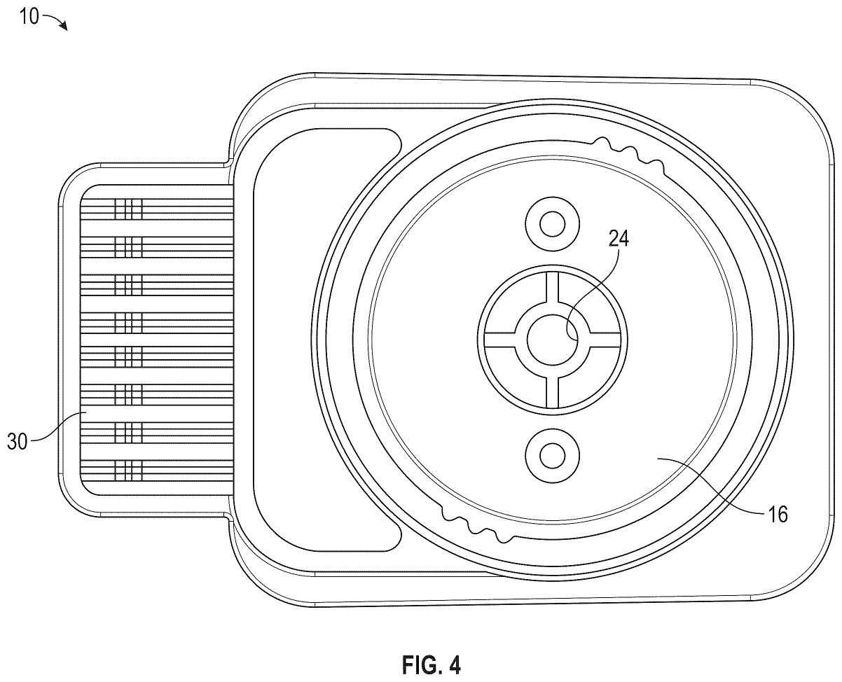

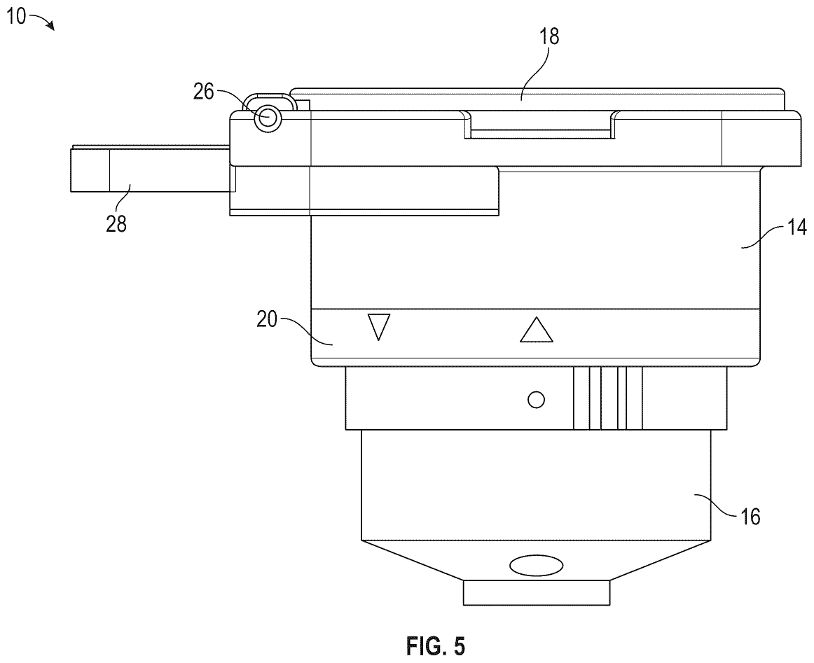

With reference to FIGS. 1-8, a reusable coffee and beverage pod 10 according to an embodiment of the present invention is shown. The coffee and beverage pod 10 includes a generally cup shaped body 12 sized and configured to be received in a filter cartridge holder of a beverage or coffee machine (not shown) in a manner generally known in the art. The body 12 includes a generally cylindrical upper chamber 14, a generally conical lower chamber 16, and an actuator in the form of a rotatable control ring 20 intermediate, and interconnecting, the upper chamber 14 and the lower chamber 16. As best shown in FIGS. 1 and 3, the reusable coffee and beverage pod 10 includes a lid 18 pivotally connected to the upper chamber 14 about hinge 26. The lid 18 encloses the open end of the upper chamber 14 and includes an inlet opening or aperture 22 coaxial with the upper and lower chambers 14, 16 for the ingress of heated water. As best shown in FIGS. 2 and 4, the lower chamber 16 includes an outlet opening or aperture 24 at the lower end thereof and coaxial with the upper and lower chambers 14, 16. As further shown in FIGS. 1-8, a tab 28 extends from one side of the body 12 adjacent to the hinge 26 and is graspable by a user to manipulate the pod 10, such during removal and insertion of the pod 10 with respect to the beverage or coffee machine. As best shown in FIG. 4, an underside of the tab 28 may include an identifying or detection feature or element 30 that enables the beverage or coffee machine to detect when the pod 10 is inserted within the filter cartridge holder. In an embodiment, the identifying feature may be a magnetic strip, a strip of metal, or the like.

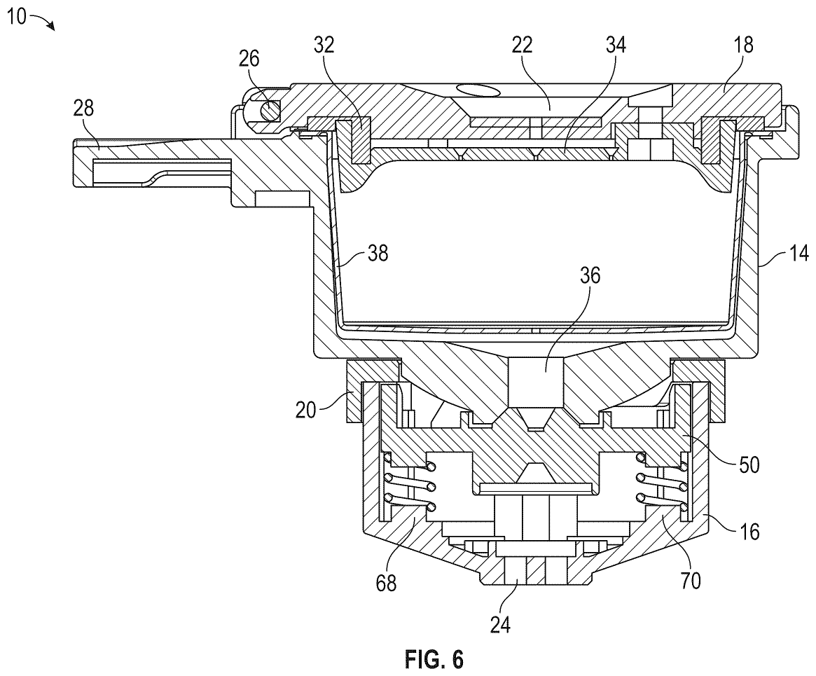

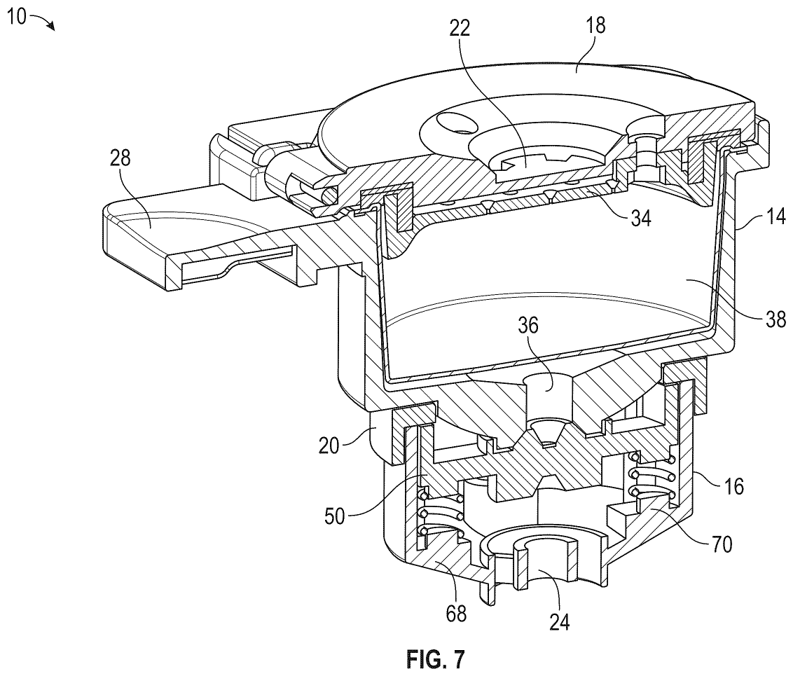

As illustrated in FIGS. 6 and 7, the internal configuration of the coffee and beverage pod 10 is shown. In an embodiment, the coffee and beverage pod 10 includes a sealing element 32 such as an O-ring or the like that forms a substantially water-tight seal between the lid 18 and the upper rim of the upper chamber 14 of the body 12 when the lid 18 is in the closed position. The coffee and beverage pod 10 also includes a shower head 34 that is configured distribute water evenly, via an array of outlets, through coffee grounds or other beverage ingredient placed within the upper chamber 14, as disclosed below. In an embodiment, the sealing element 32 and shower head 34 are integrated with the lid 18. As also shown therein, the upper chamber 14 includes a generally conical bottom having an outlet 36 in fluid communication with the lower chamber 16, which similarly has a generally conical bottom having outlet 24. In an embodiment, a lower portion of the outlet 36 has the shape of an inverted cone (having a diameter at a lower end that is greater than a diameter at a location above the lower end). A generally cylindrical filter element 38 is located within the upper chamber 14 and is configured to retain a beverage ingredient such as coffee grounds, tea leaves or the like, but allows for the passage of liquid therethrough. In an embodiment, the filter element 38 may take a variety of forms such as, for example, a fine mesh screen, a porous fabric, or the like.

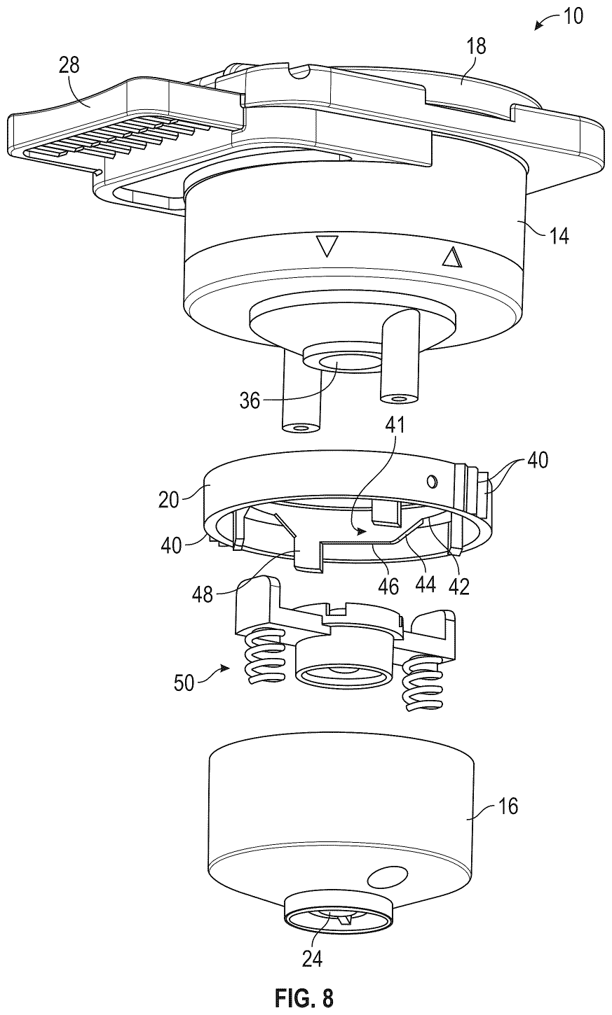

FIG. 8 best illustrates the configuration of the control ring 20. As shown therein, the control ring 20 is annular in shape and includes a plurality of ridges 40 on the exterior surface thereof, which function as gripping elements enabling a user to grasp and rotate the control ring 20 relative to the upper and lower chambers 14, 16 as described in detail below. An inner periphery of the control ring 20 includes a cam structure 41 which includes a first land 42, adjacent to an upper end of the control ring 20, an angled or inclined surface 44, a second land 46 adjacent to the lower end of the control ring 20 (i.e., at a plane lower than the first land 42), and a position stop 48. A similar cam structure may be located on an inner peripheral surface of the control ring 20 on an opposite side thereof.

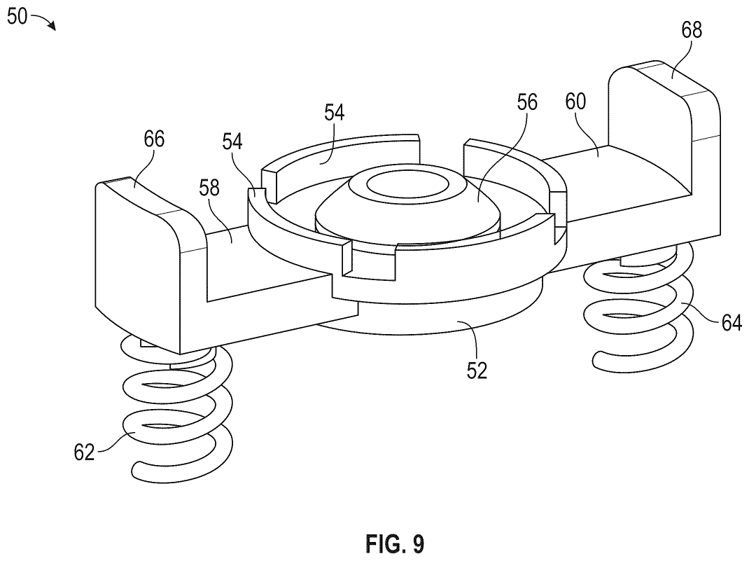

With reference to FIGS. 8 and 9, the coffee and beverage pod 10 also includes a pressure valve 50 positioned within the lower chamber 16. The pressure valve 50 includes a generally cylindrical central body portion 52 having a frusto-conical sealing element 56 dimensioned and shaped so as to be received within the lower portion of outlet 36 of the upper chamber 14, as discussed in detail below, and a plurality of circumferential walls 54 arranged concentrically with, and spaced from, the sealing element 56. The pressure valve 50 further includes a pair of opposed arms 58, 60 extend from opposite sides of the central body portion 52, and a pair of biasing elements such as, for example, compression springs 62, 64, connected to the arms 58, 60 and depending downwardly therefrom. As best shown in FIG. 7, the springs 62, 64 are received on corresponding posts 66, 68 that extend upwardly from the bottom of the lower chamber 16. As further shown in FIG. 9, the pressure valve 50 further includes a pair of upstanding tabs or followers 66, 68 configured to interface with the cam structure 41 of the control ring 20 in the manner hereinafter described.

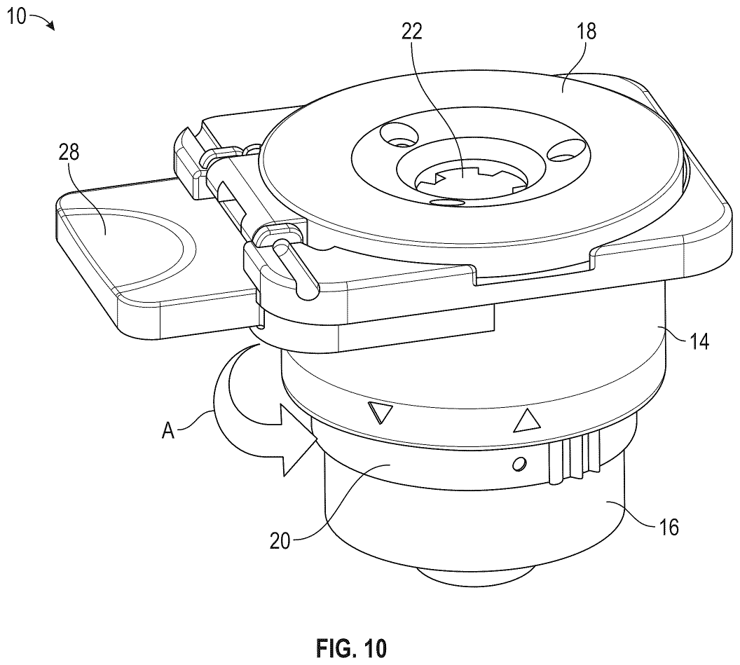

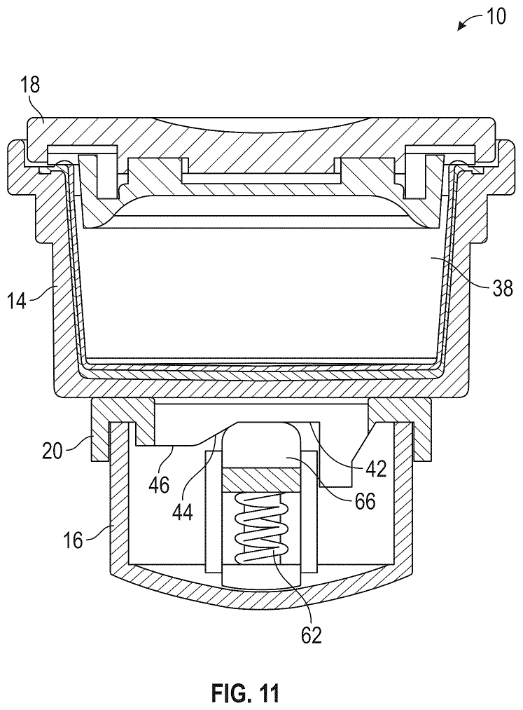

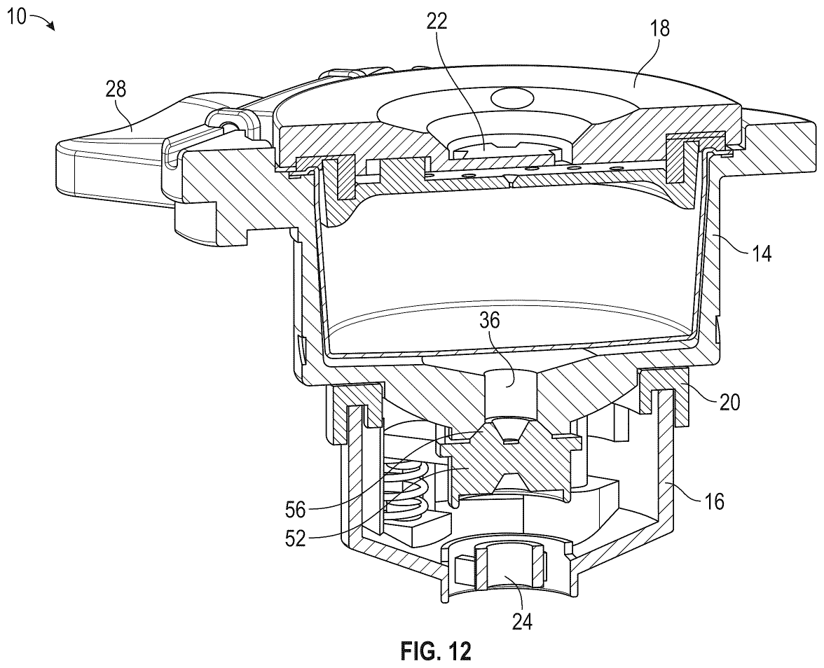

Turning now to FIGS. 10-15, the pressure valve 50 is selectively adjustable so as to allow for either high pressure brewing or low-pressure brewing, as desired, and in dependence upon the type of beverage to be produced. With reference to FIGS. 10-12, the pressure valve 50 can be moved to the closed position by rotating the control ring in a counterclockwise direction, as shown by arrow A in FIG. 10. In this position, the follower 66 of the pressure valve 50 is seated against the first land 42 of the cam structure 41, and the springs 62, 64 bias the pressure valve 50, including the central body portion 52, upwards. In this position, the frusto-conical sealing element 56 of the pressure valve 50 is seated against the inverted cone shaped portion of outlet 36 in the bottom of the upper chamber 14, as best shown in FIG. 12. This is the closed position of the pressure valve 50.

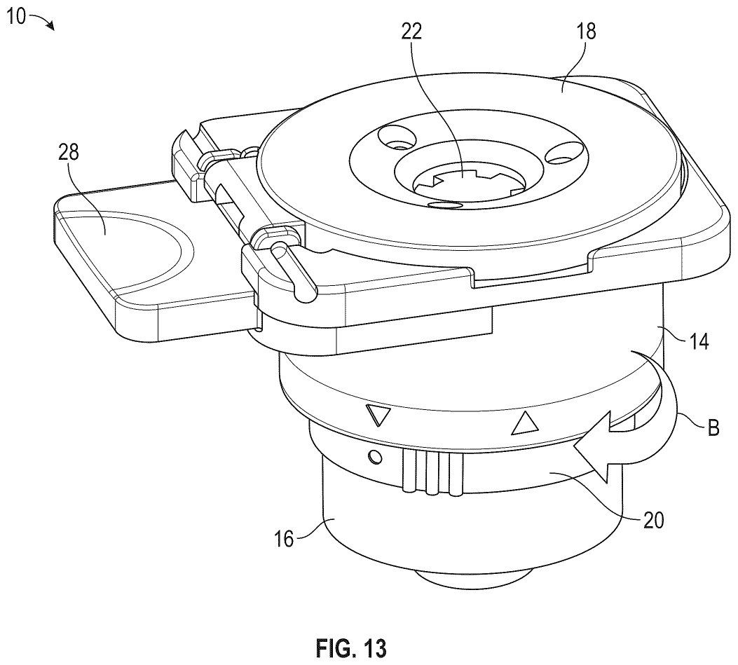

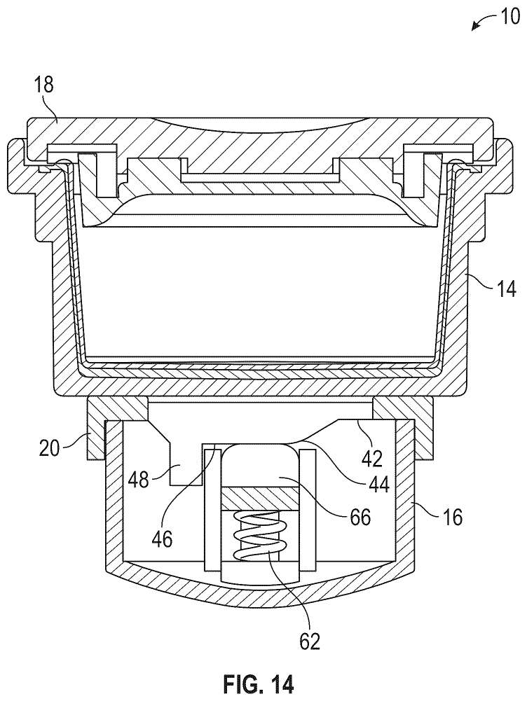

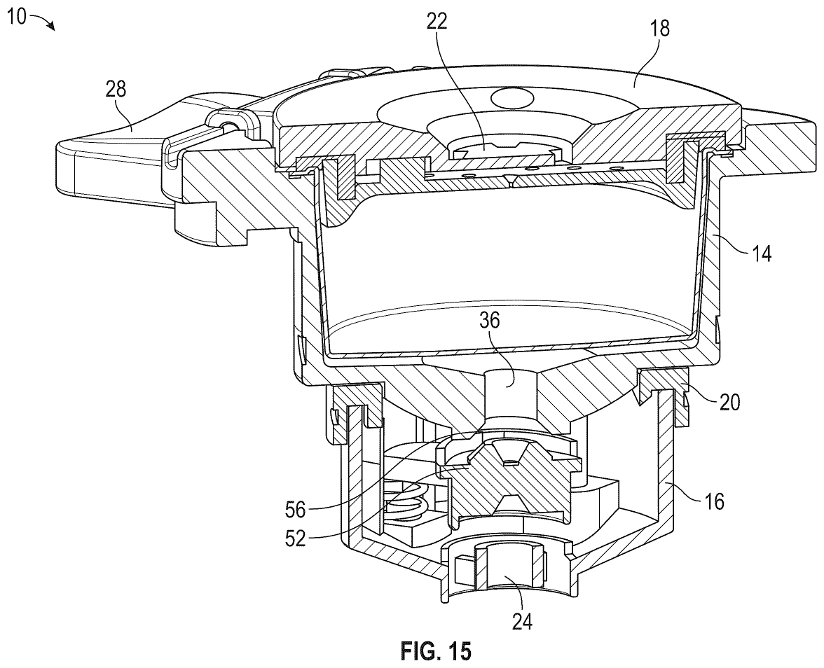

With reference to FIGS. 13-15, the pressure valve 50 can be moved to the open position by rotating the control ring 20 in a clockwise direction, as shown by arrow B in FIG. 13. This clockwise rotation of the control ring 20 causes the cam structure 41 to exert a downwards force on the follower 66 and/or 68 to move the pressure valve 50 downwardly. In particular, in its closed state (of FIGS. 10-12), the first land 42 of the cam structure 41 is engaged with the follower 66. Rotating the control ring 20 causes the inclined surface 44 of the cam structure 41 to move into contact with the follower 66 of the pressure valve 50, which pushes the pressure valve 50 downwardly against the bias of the springs 62, 64 (thus compressing the springs 62, 64). As the control ring 20 continues to be rotated, the inclined surface 44 continues to push the pressure valve 50 downwardly until the second land 46 is moved into contact with the follower 66, as best shown in FIG. 14. Position stop 48 prevents over rotation of the control ring 20 (by abutting the side of the follower 66). As best shown in FIG. 15, in this open position, the frusto-conical sealing element 56 of the pressure valve 50 is spaced from the inverted cone shaped portion of outlet 36 in the bottom of the upper chamber 14. This is the open position of the pressure valve 50.

As will be appreciated, the brewing of espresso requires using fine coffee grounds for quick extraction. The brewing uses high pressure (typically 5-12 bar) to force the hot water to pass through the grounds, resulting in a high concentration of coffee with crema on top. Drip coffee, on the other hand, requires much lower pressure (typically <2 bar) for brewing. Such coffee uses a medium to coarse grind size for brewing. The brewing process takes a longer time to extract the coffee and the water is dripped by gravity, resulting in a clean cup of coffee with no crema on top.

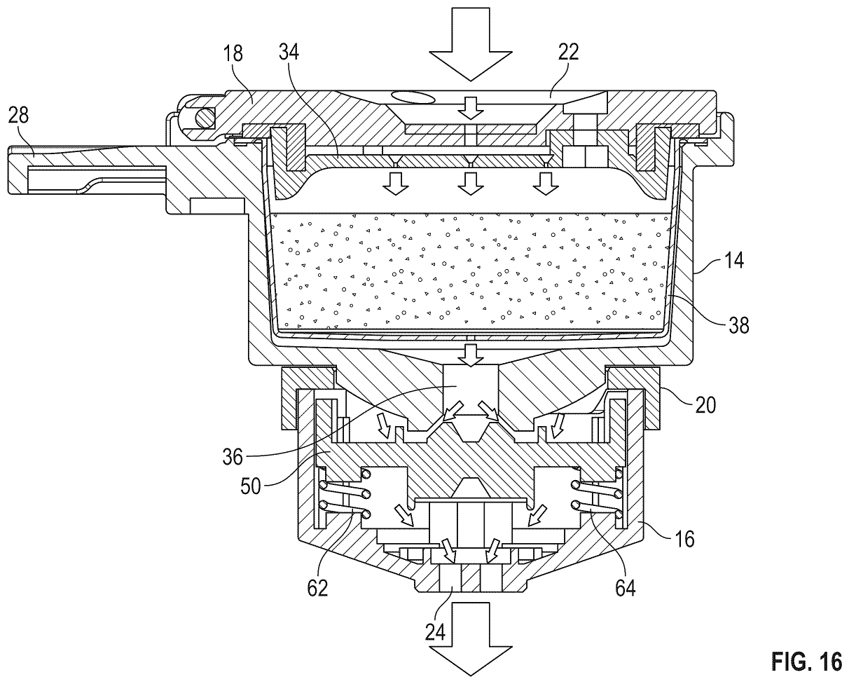

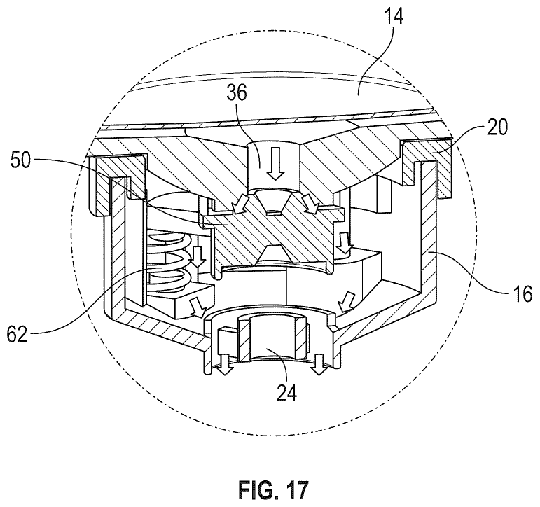

Importantly, the reusable coffee and beverage pod 10 can be utilized to produce a beverage using high pressure brewing (for example, to produce an espresso beverage) or low-pressure brewing (for example to produce drip-style coffee). Regardless of the mode of operation, coffee grounds of a desired grind size, or a beverage ingredient, can be placed within the filter basket 38 and the lid 18 can then be closed. The pod 10 is then inserted into a filter cartridge holder of a beverage or coffee machine (not shown) in a manner generally known in the art, and a brewing cycle is initiated (typically by the press of a button). Upon commencement of the brewing cycle, heated water enters the upper chamber 14 through the inlet opening 22 of the lid 18, and is evenly distributed throughout the coffee grounds within the filter basket 38 via the shower head 34. The heated water passes through the coffee grounds and then through the filter basket/filter element 38 and out of the outlet 36 of the upper chamber 14. From there, the water passes past the pressure valve 50 and into the lower chamber 16. The lower chamber 16 collects the coffee and allows the coffee to flow out of the outlet 24 in the bottom thereof as a stream, where it can be collected in a coffee cup or the like. This water flow pathway is illustrated in FIGS. 16 and 17 and, as stated above, is the same regardless of the mode selected (i.e., regardless of whether the pressure valve 50 is in the open position or closed position).

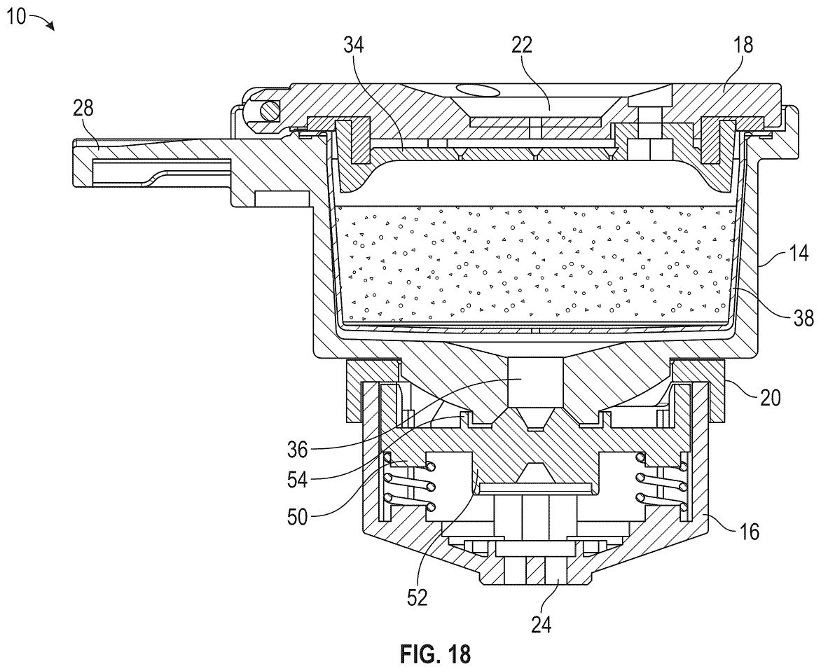

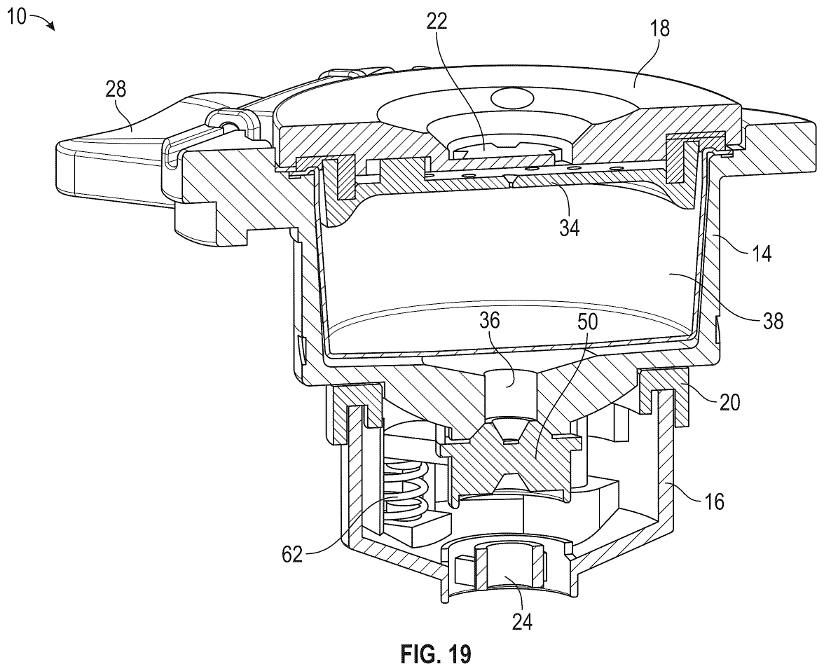

To configure the pod 10 or use in a high-pressure brewing mode of operation, such as the production of espresso, the control ring 20 is rotated to the closed position so that the pressure valve 50 abuts the lower end of the upper chamber 14 and so that sealing element 56 is received in the lower portion of outlet 36, as shown in FIGS. 18 and 19. As heated water is distributed to the coffee grounds in the filter basket 38 of the upper chamber 14 in the manner disclosed above, pressure increases in the upper chamber 14. This pressure increase within the upper chamber 14 forces the water through the coffee grounds and the filter element 38. When the pressure within the upper chamber 14 builds up to an extent that it overcomes the upward biasing force of the springs 62, 64, it forces the pressure valve 50 downward, against the spring bias, creating an annular space between the frusto-conical sealing element 56 of the pressure valve 50 and the bottom of upper chamber 14, through which the coffee infused water can escape and enter the lower chamber 16, and ultimately exit through the outlet 24. In an embodiment, the upward biasing elements 62, 64 may be designed and/or selected so that a pressure of about 5 to about 12 bar in the upper chamber 14 can overcome the spring bias and urge the pressure valve 50 downwardly against such spring bias. As will be appreciated, therefore, the pod 10, when the pressure valve 50 thereof is in the closed position, is particularly suited to brewing espresso as it produces a high concentration of coffee with crema on top.

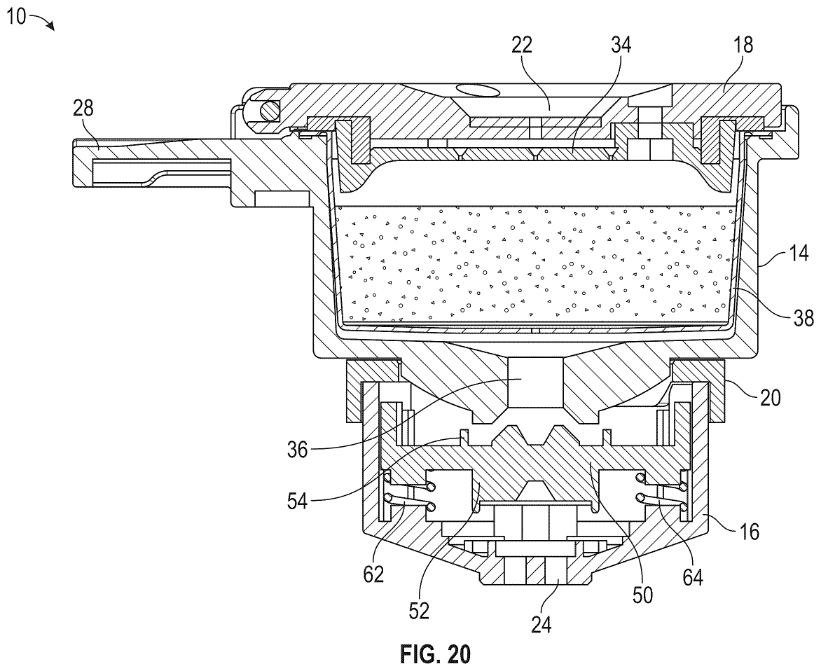

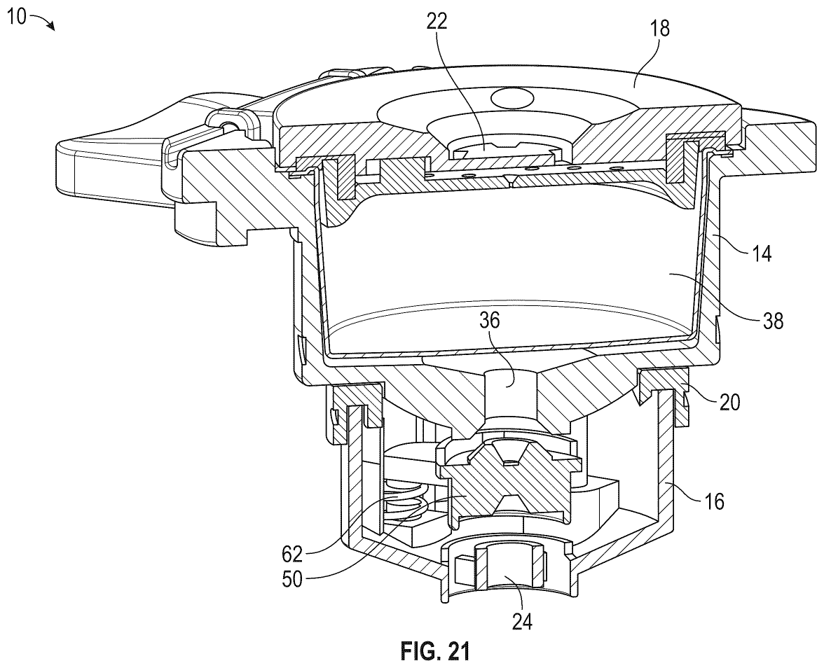

Conversely, to configure the pod 10 for use in a low-pressure brewing mode of operation, the control ring 20 is rotated to the open position so that the pressure valve 50 is spaced from the lower end of the upper chamber 14 and so that sealing element 56 is spaced from the lower portion of outlet 36, as shown in FIGS. 20 and 21. As heated water is distributed to the coffee grounds in the filter basket 38 of the upper chamber 14, it is permitted to freely flow under the force of gravity through the coffee grounds. The coffee infused water exits the filter element 38 and the upper chamber 14 through outlet 36, and enters the lower chamber 16 through the open pressure valve 50, where it then collects and ultimately exits through outlet 24. As the pressure valve 50 is never in the closed position, significant pressure cannot build up in the upper chamber 14 (in contrast to the high-pressure brewing method described above). That is, because the pressure valve is in the open position, there is much less restriction on the flow of water from the upper chamber 14 to the lower chamber 16. This brewing process, at low pressures (e.g., under 2 bar), results in coffee extraction without crema, producing a drip-style coffee beverage.

Regardless of the particular mode the pod 10 is placed in (high pressure or low-pressure brewing), the pod 10 is intended to be reused in subsequent brewing operations. In particular, once a beverage is brewed in the manner described above, a user can dump out the used coffee grounds or beverage ingredients, rinse the upper chamber 14 and filter basket 38, and then refill the pod 10 with whatever beverage ingredients/material is desired for a subsequent single serve beverage.

As disclosed above, importantly, the reusable coffee and beverage pod 10, by being selectively configurable in either high pressure or low-pressure modes of operation, is thus capable of producing a variety of different beverages (e.g., espresso and drip style coffee). This level of functionality has heretofore not been seen in the art and, particularly in the single-serve coffee maker art. Moreover, traditional espresso brewing requires a skilled user, as slight variations in the evenness of the coffee bed and tamping force can greatly affect the brewing pressure. The pod 10 of the present invention, however, removes these variables, and the pressure valve 50 ensures proper pressurization within the brewing chamber which reduces misuses and produces consistent coffee product. While the present invention has been disclosed above as being suitable for single-serve brewing, it is not intended that the present invention be so limited in this regard. In particular, it is contemplated that the pod 10 can be scaled up in volume so as to produce a greater volume of a beverage using either high-or low-pressure brewing.

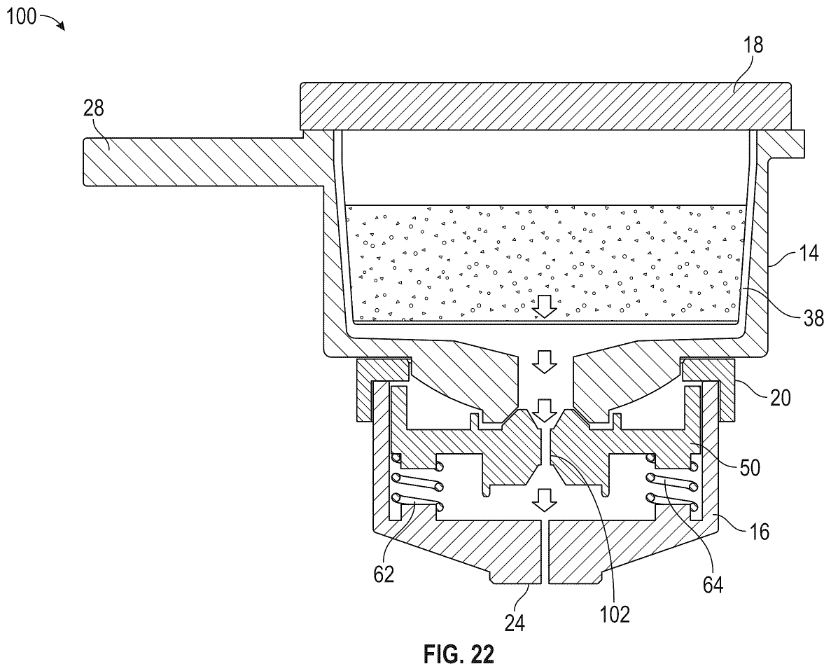

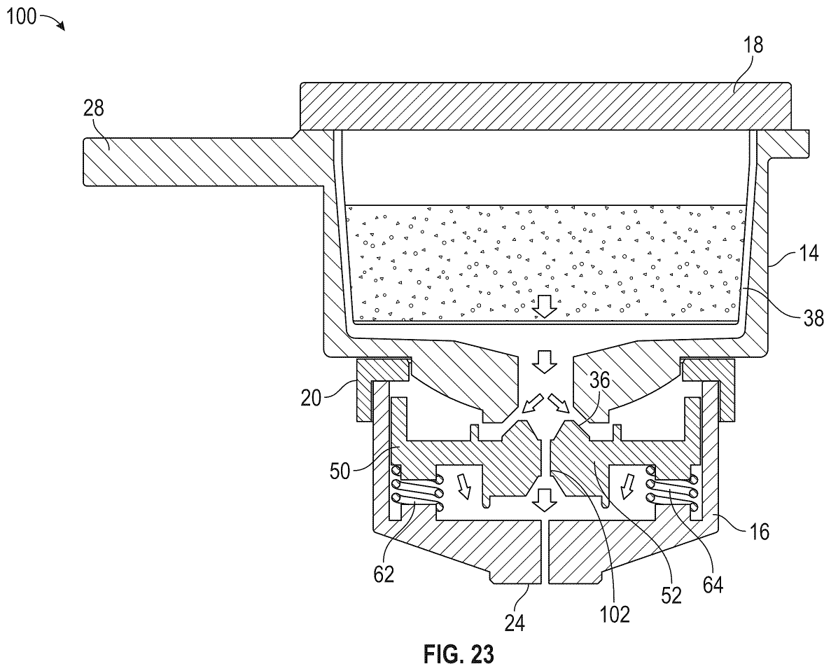

Turning now to FIGS. 22 and 23, a reusable coffee and beverage pod 100 according to an embodiment of the present invention is shown. The beverage pod 100 is generally identical to the beverage pod 10 disclosed above, where like reference numerals designate like parts. As illustrated therein, however, the central body 52 of the adjustable pressure valve 50 includes a small diameter throughbore 102 located concentrically with the central body 52, upper chamber 14 and lower chamber 16. In an embodiment, the throughbore 102 is a pinhole. During high pressure brewing, the pressure valve 50 is closed (as disclosed above in connection with pod 10), leaving the throughbore 102 as the only fluid pathway between the upper chamber 14 and the lower chamber. When the pressure within the upper chamber 14 builds up to a desired brewing pressure, such pressure forces the liquid to pass through the throughbore 102 into the lower chamber 16, and ultimately out of outlet 24 to produce a beverage such as espresso, as shown in FIG. 22. In an embodiment, diameter of the throughbore 102 is selected to limit the liquid flow and control the brewing pressure within the upper chamber 14. For example, in an embodiment, the diameter of the throughbore 102 is chosen so that a pressure in excess of about 5 bar in the upper chamber 14 is necessary to push the liquid through the throughbore 102 and into the lower chamber 16. Low pressure brewing can be carried out in the manner disclosed above in connection with pod 10, where control ring 20 is rotated to open the pressure valve 50.

With specific reference to FIG. 23, the reusable coffee and beverage pod 100 is configured to prevent an over pressure condition within the pod 100. In particular, in the case where excess pressure builds up within the upper chamber 14, the pressure valve 50 is pushed downwardly by such pressure, causing liquid to flow along the opening between the central body 52 and the lower end of the upper chamber 14 to release the excess pressure, as shown in FIG. 23. In an embodiment, the biasing force of the springs 62, 64 is carefully selected to control the pressure valve opening pressure. In various embodiment, the spring elements 62, 64 are selected so that a pressure in excess of about 20 bar, about 15 bar or about 12 bar in the upper chamber 14 is necessary to urge the valve downwardly to allow flow past the valve 50, as shown in FIG. 23.

In an embodiment, reusable coffee and beverage pods 10, 100 are configured for use with a variety of existing coffee or beverage making appliances and may include a lid design that avoids collision with a piercing blade on both the top and bottom. In an embodiment, the pods 10, 100 can be utilized with grind-and-brew style coffee machines, and can receive ground coffee directly from the grinder of such machines. In other embodiments, a specialized grind and brew style machine, or single-serve beverage appliance may be provided to receive the beverage pods 10, 100.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A coffee and beverage pod, comprising:
a body having an interior volume for receiving a beverage ingredient;
wherein the coffee and beverage pod is selectively configurable in a low-pressure brewing mode and a high-pressure brewing mode;
wherein in the low-pressure brewing mode, a first pressure is necessary to allow for the flow of liquid from the interior volume out of an outlet in the body; and
wherein in the high-pressure brewing mode, a second pressure within the interior volume is necessary to allow for the flow of liquid from the interior volume out of the outlet; and
wherein the second pressure is greater than the first pressure.

2. The coffee and beverage pod of claim 1, wherein:
the body includes an upper chamber having an outlet, a lower chamber having an outlet, and an adjustable pressure valve intermediate the upper chamber and the lower chamber.

3. The coffee and beverage pod of claim 2, wherein:
the adjustable pressure valve includes a sealing element; and
wherein the adjustable pressure valve is moveable between a first position where the sealing element is spaced from the outlet of the upper chamber to provide fluid communication between the upper chamber and the lower chamber, and a second position where the sealing element engages the outlet of the upper chamber to fluidly isolate the upper chamber from the lower chamber.

4. The coffee and beverage pod of claim 3, wherein:
the adjustable pressure valve includes at least one biasing element configured to bias the pressure valve to the second position.

5. The coffee and beverage pod of claim 4, further comprising:
an actuator configured to move the adjustable pressure valve between the first position and the second position;
wherein the first position corresponds to the low-pressure brewing mode; and
wherein the second position corresponds to the high-pressure brewing mode.

6. The coffee and beverage pod of claim 5, wherein:
the actuator is a rotatable ring.

7. The coffee and beverage pod of claim 6, wherein:
the rotatable ring includes a cam structure configured to urge the adjustable valve downwardly, against the bias of the at least one biasing element, to the first position upon rotation of the rotatable ring in a first direction.

8. The coffee and beverage pod of claim 7, wherein:
the cam structure includes a first land, a second land spaced vertically from the first land, and an angled surface extending between the first land and the second land.

9. The coffee and beverage pod of claim 2, wherein:
the upper chamber includes filter element.

10. The coffee and beverage pod of claim 1, wherein:
the first pressure is zero pressure or the force of gravity; and
the second pressure is greater than about 5 bar.

11. The coffee and beverage pod of claim 2, wherein:
the adjustable pressure valve includes a throughbore providing fluid communication between the upper chamber and the lower chamber.

12. A coffee and beverage pod, comprising:
an upper chamber configured to receive a beverage ingredient, and having an outlet,
a lower chamber having an outlet; and
an adjustable pressure valve having a sealing element, the adjustable pressure valve being moveable between a first position where the sealing element is spaced from the outlet of the upper chamber to provide fluid communication between the upper chamber and the lower chamber, and a second position where the sealing element engages the outlet of the upper chamber to fluidly isolate the upper chamber from the lower chamber.

13. The coffee and beverage pod of claim 12, wherein:
the adjustable pressure valve includes a biasing element configured to bias the pressure valve to the second position.

14. The coffee and beverage pod of claim 13, further comprising:
an actuator configured to move the adjustable pressure valve between the first position and the second position.

15. The coffee and beverage pod of claim 14, wherein:
the actuator includes a cam structure configured to urge the adjustable valve downwardly, against the bias of the biasing element, to the first position upon actuation of the actuator.

16. The coffee and beverage pod of claim 15, wherein:
the cam structure includes a first land, a second land spaced vertically from the first land, and an angled surface extending between the first land and the second land.

17. The coffee and beverage pod of claim 16, wherein:
the actuator is a rotatable ring.

18. The coffee and beverage pod of claim 12, wherein:
the upper chamber includes filter element.

19. A method for brewing a beverage, comprising the steps of:
placing a beverage ingredient inside an upper chamber of a beverage pod, the upper chamber having an outlet; and
configuring the beverage pod for one of a high-pressure brewing mode or a low-pressure brewing mode;
wherein configuring the beverage pod for the high-pressure brewing mode includes moving an adjustable pressure valve to be in contact with the outlet to inhibit fluid from exiting the upper chamber through the outlet; and
wherein configuring the beverage pod for the low-pressure brewing mode includes moving the adjustable pressure valve to a position where it is spaced from the outlet to allow fluid to exit the upper chamber through the outlet.

20. The method according to claim 19,
wherein moving the adjustable pressure valve includes rotating a control ring of the beverage pod.
